(19) United States
(12) Patent Application Publication
(10) Pub. No.: US 2015/0186078 A1
(43) Pub. Date: Jul. 2, 2015

(54) PRINT MANAGEMENT SYSTEM, INFORMATION PROCESSING APPARATUS, AND PRINT MANAGEMENT METHOD

(71) Applicant: CANON KABUSHIKI KAISHA, Tokyo (JP)

(72) Inventor: Manabu Ozawa, Kawasaki-shi (JP)

(21) Appl. No.: 14/569,614

(22) Filed: Dec. 12, 2014

(30) Foreign Application Priority Data
Dec. 26, 2013 (JP) 2013-270125

(51) Int. Cl. G06F 3/12

(52) U.S. Cl. CPC G06F 3/1205; G06F 3/1275; G06F 3/1238

(57) ABSTRACT

A system is configured in which user information of a user requesting responsibility to be taken for a number of sheets and user information of a user requested to take responsibility for the number of sheets are stored in association with job information, and in the case where the job has been executed, the user information of the user requested to take responsibility for the number of sheets is referred to and that user takes responsibility for the number of sheets.

### BACKGROUND OF THE INVENTION

1. Field of the Invention

The present invention relates to print management systems, information processing apparatuses, and print management methods capable of authenticating users, performing billing processes, and so on.

2. Description of the Related Art

Businesses are recently paying more and more attention to security and cost-related issues, and systems that use smartcards, PIN codes, user IDs, and the like for personal authentication are being introduced into complex machines known as multi-function peripherals (MFPs), which are capable of printing, copying, scanning, and so on. Furthermore, authenticating users and associating individual users with usage states is being used to analyze usage states on a user-by-user basis, manage billing, and so on. For example, setting a number of sheets that can be printed for each user, and enabling a restriction so that the user cannot print more than the set number of sheets is one scheme being used to suppress costs.

While systems that require personal authentication are advantageous in terms of security, cost management, and so on, there are cases where a user that has input a print job must physically go to the MFP and authenticate him/herself in order to start the output process. Techniques that assume a variety of use cases are being proposed in order to improve the usability of such a system. For example, Japanese Patent Laid-Open No. 2011-199635 proposes a system that associates multiple user IDs with a job, making possible a setting that makes it possible to allow a third party to use printed material instead of only the person who originally configured the print job.

In this conventional printing system, a count assignment (or a billing destination) for the number of printed sheets is uniquely fixed to a count assignment set for the system being used. A problem arising in a use case where a first user requests a second user to execute a print in the first user's stead will be described hereinafter.

According to Japanese Patent Laid-Open No. 2011-199635, the usability is improved by distinguishing the relationship between a person who input a print job and a person who actually executes and outputs the print job; however, as mentioned above, the count assignment for the number of printed sheets is uniquely fixed to the count assignment set for the system. In the case where the system has a setting in which, for example, a count for the number of printed sheets is assigned to the person who executes the print job, the count value for the number of printed sheets will be added to the user who actually executes the print even in the case where a third party is only requested to pick up the printed material. In this case, the user that executes the print must therefore take responsibility for the number of printed sheets despite the fact that s/he simply output the printed material in another user's stead. If the system is such that, for example, a limit is set on the number of printed sheets for each user and the printing costs are billed to the department to which the user belongs, the original purpose of the system cannot be realized if the number of printed sheets is also assigned to the substitute user.

### SUMMARY OF THE INVENTION

In light of these problems, the present invention provides a print management system capable of flexibly handling a variety of use cases.

Accordingly, an information processing apparatus according to the present invention has the following configuration.

The information processing apparatus includes a specifying unit that specifies a requested user who is a user requested to take responsibility for some or all of a print amount for printing executed based on print data, and a generating unit that, based on details of the specifying performed by the specifying unit, generates print data including a requested user list specifying the requested user.

According to another aspect of the present invention, an information processing apparatus that manages print amounts on a user-by-user basis includes: a unit that receives, from a first terminal, print data including a requested user list of users requested to take responsibility for some or all of a print amount for printing executed based on print data; a unit that generates responsibility request information based on the requested user list and saves the responsibility request information; a unit that sends and registers the print data in an image forming apparatus; and a counting unit that, in response to a notification from the image forming apparatus that the print data is to be printed, counts some or all of the print amount based on the print data as a print amount for the requested user in the case where the requested user is specified in the print data.

According to the present invention, a request to take responsibility for a number of sheets can be issued to a user that is not the user executing a print job, and thus it is possible to properly specify the user who is to take responsibility in a variety of specific use cases.

Further features of the present invention will become apparent from the following description of exemplary embodiments with reference to the attached drawings.

### BRIEF DESCRIPTION OF THE DRAWINGS

FIG. 1 is a block diagram illustrating an overall print management system 100 according to an embodiment.

FIG. 2A is a block diagram illustrating user terminals 101, 102, and 103 according to an embodiment in detail.

FIG. 2B is a block diagram illustrating MFPs 104 and 105 according to an embodiment in detail.

FIG. 2C is a block diagram illustrating a print management server 106 according to an embodiment in detail.

FIG. 3 illustrates the flow of a print job registration method according to an embodiment.

FIG. 4 illustrates a flow performed when a print job is executed according to an embodiment.

FIG. 5 is a diagram illustrating an example of a responsibility allocation request destination user selection screen and an example of a responsible party candidate search screen.

FIG. 6 is a diagram illustrating an example of responsibility request information.

FIG. 7 is a diagram illustrating an example of a job selection screen.

FIG. 8 illustrates a flow carried out when a job is executed in the case where responsibility permission can be selected.

FIG. 9 illustrates a flow carried out in the case where a user requested to take responsibility is allowed to select whether or not to permit the taking of responsibility.

FIG. 10 is a diagram illustrating an example of a responsibility permission selection screen.

FIG. 11A illustrates a flow carried out when registering responsibility permission information.

FIG. 11B illustrates a flow for registering a job that includes responsibility permission information.

FIG. 11C illustrates a flow for executing a job that includes responsibility permission information.

FIG. 12 is a diagram illustrating an example of a permission-issuing user specifying screen 1200 and an example of a requested user designation screen 1209.

FIG. 13 illustrates a flow carried out in the case where a responsibility request sheet number has exceeded a sheet limit number for the requested party and the excess amount is set as a responsibility request for another user.

### DESCRIPTION OF THE EMBODIMENTS

### First Embodiment

Hereinafter, embodiments of the present invention will be described with reference to the drawings.

Overall System Configuration

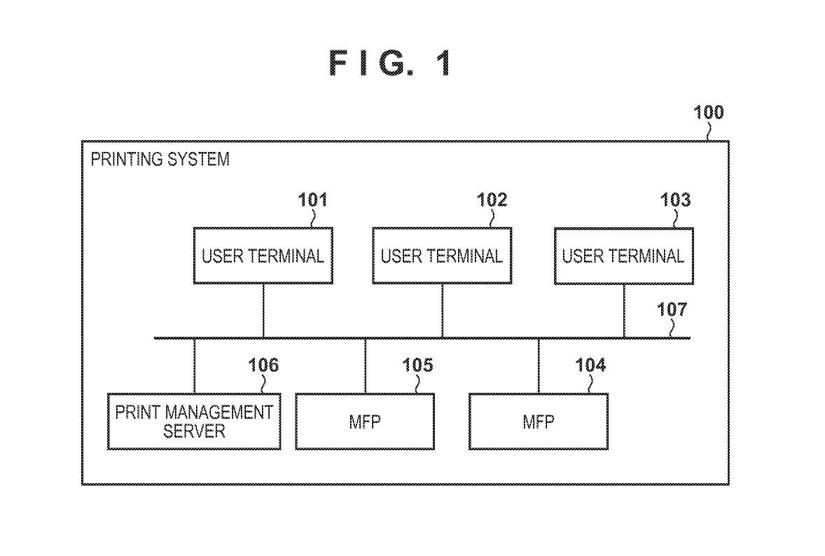

FIG. 1 is a block diagram illustrating an overall print management system 100 that manages printing according to the present embodiment. The respective blocks are connected via a network 107. The respective blocks are connected to the network 107 via a wired LAN (local area network), a wireless LAN, or the like. User terminals 101, 102, and 103 are electronic devices such as information processing apparatuses that can connect to the network, and are terminals such as desktop PCs, laptop PCs, tablet PCs, smartphones, or the like through which users can make job settings or the like. Details will be given later. MFPs 104 and 105 are multifunction peripherals that can connect to the network, and function as image forming apparatuses that receive print data sent from a print management server 106, which is also an information processing apparatus and will be described later, and print onto a paper medium. Details will be given later. Although MFPs are employed in the present embodiment, SFP (single function peripherals) provided only with printing functions may be employed instead. The print management server 106 receives and stores print data sent from the user terminal 101 and a user ID associated with the print data. The print management server 106 furthermore holds user management information used to authenticate users in order to provide a single sign-on environment. The print management server 106 furthermore sends print data to the MFPs 104 and 105. Details will be given later. The print management server 106 includes a counter for managing print amounts for each user, and when a print job is executed, adds, to the counter of a responsibility-requested user (described later), a print amount, of the total print amount in the print job to be executed, allocated to the responsibility request destination user.

User Terminal Configuration

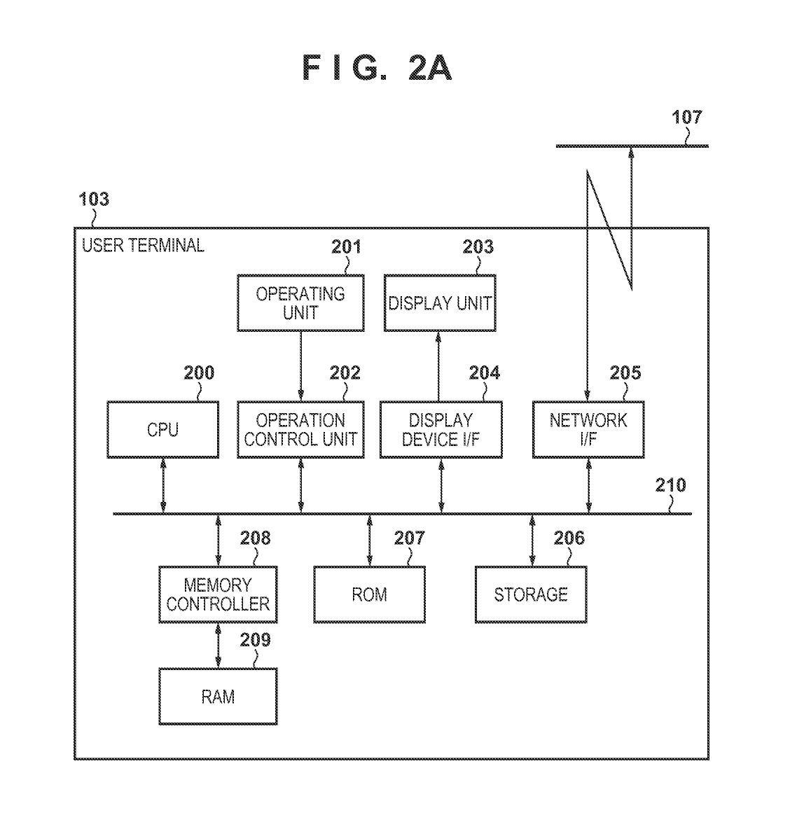

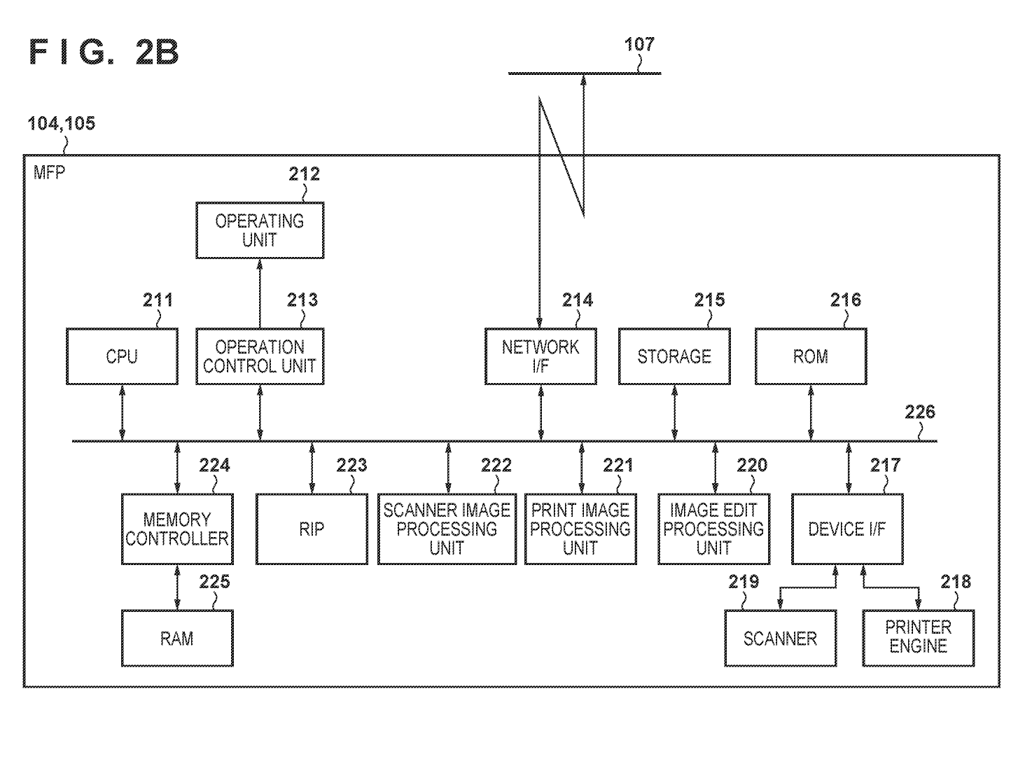

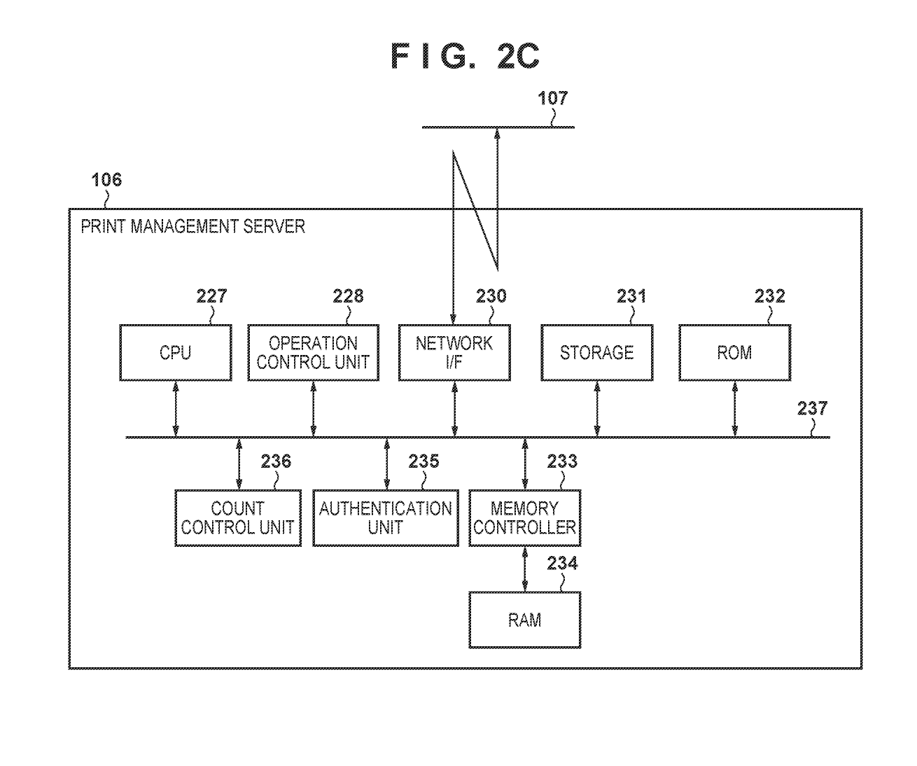

FIG. 2A is a block diagram illustrating the user terminals 101, 102, and 103 according to the present embodiment in detail. In FIG. 2A, the respective blocks are connected to a system bus 210, and a variety of functions including print job settings are realized by a CPU 200 accepting operating instructions input from an operating unit 201 or the like and causing the respective blocks to operate. The user terminals 101, 102, and 103 can connect to the network 107 via a network I/F 205, and can exchange image data, device information, and so on with the MFPs 104 and 105, the print management server 106, and the like.

The CPU 200 is a central processing unit for controlling the user terminals 101, 102, and 103, and carries out processes such as creating PDL data and generating print jobs as well as controlling various types of I/Fs by operating in accordance with applications loaded into a RAM 209, which will be described later. The operating unit 201 functions as a user interface for the user terminals 101, 102, and 103, and accepts operating instructions from a user. A keyboard, a mouse, a touch panel, a card reader, or the like is provided as the operating unit 201. An operation control unit 202 converts operating instruction information from the user input to the operating unit 201 into a format that can be executed by the MFPs 104 and 105, and provides that information to the CPU 200. A display unit 203 functions as a user interface for the user terminals 101, 102, and 103, and displays print driver configuration screens as well operating instructions to the user, results of user-input instructions, and so on. A CRT display, a liquid crystal panel, or the like is used as the display unit 203. A display device I/F operating unit 204 converts internal display data created in a rendering buffer of the user terminals 101, 102, and 103 into a format that can be displayed in the display unit 203 and outputs that data. The rendering buffer may be secured in the RAM 209, or may be provided in the display device I/F.

The network I/F 205 is realized by a modem, a LAN card, a wireless LAN access point, or the like, and inputs/outputs image data, device information, and so on from/to an external device by connecting to the network 107. Storage 206 is a high-capacity storage device such as a hard disk drive or the like, and holds application software, image data, and so on used for various types of processes. A ROM 207 is a boot ROM for the user terminal, and holds a system boot program. A memory controller 208 carries out control for accessing the RAM 209 by, for example, converting a memory access command from the CPU 200 into a command that can be interpreted by the RAM 209. The RAM 209 is a system work memory used for the CPU 200 to operate, and serves as an image memory that temporarily stores image data, holds image data for image editing, and so on. Configuration data and the like used in print jobs is also stored in the RAM 209. A magnification rate, color/black and white setting information, stapling, double-sided printing settings, and so on can be given as examples of parameters that are stored. Furthermore, information of the user who can output a job, information of a user who is responsible for a number of sheets, and so on are temporarily stored in the RAM 209 in the present embodiment. The RAM 209 may also be used as an image rendering buffer for displaying images in the display unit 203. The aforementioned units are disposed along the system bus 210.

MFP Configuration

FIG. 2B is a block diagram illustrating the MFPs 104 and 105 according to the present embodiment in detail. In FIG. 2B, the MFPs 104 and 105 have a scanner 219, serving as an image input device, and a printer engine 218, serving as an image output device, connected internally. The MFPs 104 and 105 carry out control for reading image data, print output, and so on. The MFPs 104 and 105 also carry out control for inputting/outputting device information, image data, and so on by connecting to the network 107, a public line, or the like.

A CPU 211 is a central processing unit for controlling the MFPs 104 and 105. An operating unit 212 accepts operating instructions from an operator using physical keys, a touch panel provided with multitouch functionality, or the like. The operating unit 212 further displays operating results. An operation control unit 213 converts input signals input from the operating unit into a format that can be executed by the MFPs 104 and 105, and provides those signals to the CPU 211. The operation control unit 213 is a block that carries out control for displaying image data held in a rendering buffer in a display unit provided in the operating unit 212. The rendering buffer may be provided in a RAM 114, or a dedicated rendering buffer may be provided within the operation control unit. Note that the configuration may be such that the operating unit and the display unit are provided separately, as described with reference to the user terminal 103. A network I/F 214 is realized by a modem, a LAN card, a wireless LAN access point, or the like, and inputs/outputs image data, device information, and so on from/to an external device by connecting to the network 107. Storage 215 is a high-capacity storage device such as a hard disk drive or the like, and holds application software, input image data, and so on used for various types of processes. A ROM 216 serves as a boot ROM and holds a system boot program.

A device I/F 217 connects to the scanner 219, the printer engine 218, and so on, and transfers image data. An image edit processing unit 220 carries out various types of image processes such as rotation, magnification, color processing, trimming and masking, binary conversion, multitone conversion, white paper determination, and so on for the image data. A print image processing unit 221 carries out image processing correction on the image data to be printed and output, based on the printer engine 218. A scanner image processing unit 222 performs various types of processes such as correction, processing, editing, and so on on the image data read by the scanner 219. A RIP (raster image processor) 223 expands page description language (PDL) code into image data. A memory controller 224 accesses the RAM 225 by, for example, converting a memory access command from the CPU 211, the respective image processing units, and so on into a command that can be interpreted by the RAM 225. The RAM 225 is a system work memory used for the CPU 211 to operate, and serves as an image memory that temporarily stores input image data, holds image data for image editing, and so on. The RAM 114 may also be used as an image rendering buffer for displaying images in the operating unit 212. The aforementioned units are disposed along a system bus 226.

Print Management Server Configuration

FIG. 2C is a block diagram illustrating the print management server 106 according to the present embodiment in detail. A CPU 227 is a central processing unit for controlling the print management server 106. An operation control unit 228 accepts operating instructions from an operator, primarily a server administrator or the like, through the network. The operation control unit 228 further converts input signals into a format that can be executed by the print management server 106 and provides the signals to the CPU 227. The configuration may be such that the operation control unit is further provided with an operating unit such as that described with reference to the user terminals or the MFPs, and the operating unit accepts operating instructions. A network I/F 230 is realized by a modem, a LAN card, a wireless LAN access point, or the like, and inputs/outputs image data, device information, and so on from/to an external device by connecting to the network 107. Storage 231 is a high-capacity storage device such as a hard disk drive or the like, and holds application software, input image data, and so on used for various types of processes. In the present embodiment, information such as IDs of respective users, a number of sheets printed thus far, a limit number of sheets, jobs currently standing by, and so on may further be stored. Although an output amount according to the present embodiment is counted as separate numbers of printed sheets for color and black and white, this is merely an example, and the output amount can also be referred to as a number of output sheet surfaces, billing information regarding bills charged for output materials, or print amount information indicating a print amount. The billing information is counted using a number of sheets (number of surfaces) or the like based on whether the output is color or black and white, and based on the size, for example. Furthermore, information regarding a user that takes responsibility for some or all of the number of printed sheets, or in other words, a responsibility-assigned user (also called a “print amount allocation destination”), table information associating jobs with users to whom responsibility is assigned, information regarding the number of printed sheets (or the number of printed surfaces, the billing information, the print amount) each user is responsible for, and so on, according to the present embodiment and which will be described later, are held in the storage 231. Note that the number of printed sheets for output materials assigned to a user can also be called a number of sheets the user is responsible for. A ROM 232 serves as a boot ROM and holds a system boot program. A memory controller 233 accesses a RAM 234 by, for example, converting a memory access command from the CPU 227, the respective image processing units, and so on into a command that can be interpreted by the RAM 234. The RAM 234 is a system work memory used for the CPU 227 to operate, and serves as a work memory that temporarily stores input image data, carries out responsibility requests and addition control for numbers of printed sheets, and so on. An authentication unit 235 implements a known authentication service for providing a single sign-on environment, based on an input user ID and a password. A count control unit 236 is a unit that carries out a process regarding responsibility allocation, in order to add a number of printed sheets to a user who is responsible for a charge when a job is executed. The aforementioned units are disposed along a system bus 237.

Setting/Processing Flow for Print Job in which Responsibility Can Be Requested for Number of Sheets

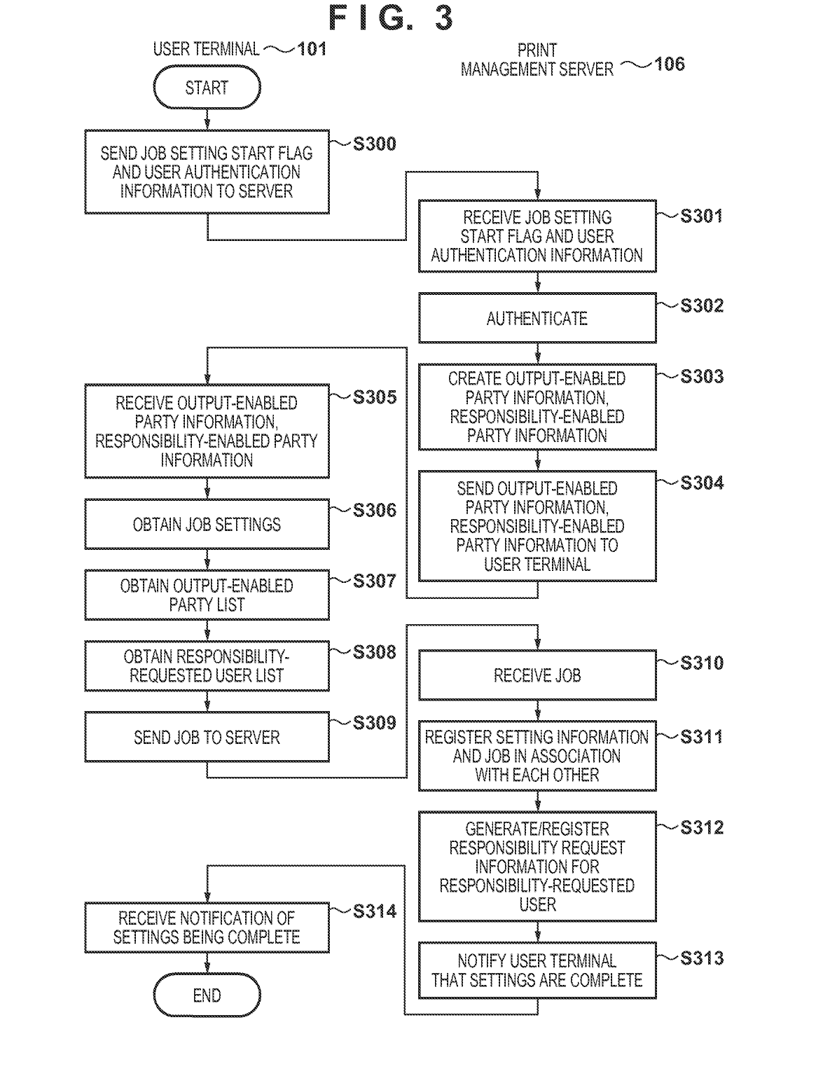

FIG. 3 illustrates a setting/processing flow for a print job in the case where a system capable of requesting a user to be responsible for a number of sheets is implemented in a system capable of setting a user who can output a print job as a print job setter. Although the user terminal 101 will be used in this example, any of the user terminals shown in FIG. 1 may be used instead. Furthermore, the following descriptions will refer to a user that instructs a print job to be executed as the “owner” of that print job. First, in S300, the CPU 200 of the user terminal 101 creates a job setting start flag, which communicates that the printer driver has been started, based on operation information from the operating unit 201. The CPU 200 furthermore creates user authentication information for the owner. To create the user authentication information, the CPU 200 may request a user ID and password to be input, or may create authentication information using a login ID provided in order to use the user terminal 101. The use of an ID card or authentication card may be employed as a trigger as well. The created job setting start flag and user authentication information are sent to the print management server 106.

Next, in S301, the flow moves to the print management server 106, where the print management server 106 receives the job setting start flag and user authentication information sent from the user terminal 101. In S302, the authentication unit 235 verifies the user authentication information received in S301 and identifies the user who is using the user terminal. In the present embodiment, the authentication unit 235 is denoted as a single module connected to the print management server 106, but the authentication unit 235 may be realized as software having the same functionality. In this case, the authentication unit 235 is realized as software executed by the CPU 227. The authentication unit 235 may also be realized as a dedicated authentication server.

In S303, the CPU 227 of the print management server 106 creates output-enabled party information and responsibility-enabled party information. The “output-enabled party” in this step refers to a user who can output a job, set by the user who is the owner of a job that specifies the print job to be executed in a later step. Naturally, the owner can output the job, and thus the owner is not included in the concept of the “output-enabled party”. Meanwhile, the “responsibility-enabled party” refers to a user who can be requested to take responsibility for a charge for some or all of a printed material (a number of printed sheets, for example). Furthermore, in this flow, the user who sets the job (the owner, in other words) can set the output-enabled party and the responsibility-enabled party as the same user, or as different users. Here, the “output-enabled party” and the “responsibility-enabled party” basically include all users who can access the print management server 106. In S304, the output-enabled party information and the responsibility-enabled party information created in S303 are sent to the user terminal 101.

S305 is a step in which the user terminal 101 receives the output-enabled party information and the responsibility-enabled party information sent from the print management server 106. In S306, the CPU 200 obtains job setting information and stores the information in the RAM 209. Specifically, the printer driver executed by the CPU 200 displays a UI screen in the display unit 203. The user inputs the job setting information in accordance with that UI, through operations made using the operating unit 201. Based on the input information from the operating unit 201, the CPU 200 obtains the job setting information and stores the information in the RAM 209. In S307, the CPU 200 obtains an output-enabled party list and stores the list in the RAM 209. Specifically, the CPU 200 displays an output-enabled party selection screen in the display unit 203 based on the output-enabled party information received by the user terminal 101 in S305. The user is then allowed to select users who are capable of output, through operations made using the operating unit 201. Then, in this step, the CPU 200 stores a list of the selected users in the RAM 209 as the output-enabled party list, based on input information from the operating unit 201.

In S308, the CPU 200 obtains a responsibility-requested user list and stores the list in the RAM 209. Specifically, the CPU 200 displays a selection screen for selecting responsibility-requested users (the responsibility-requested user list) in the display unit 203 based on the responsibility-enabled party information received by the user terminal 101 in S305. The operating user is then allowed to select users who are to be requested to take responsibility for a number of printed sheets, through operations made using the operating unit 201. Then, in this step, the CPU 200 stores the selected users in the RAM 209 as the responsibility-requested user list, based on the information from the operating unit 201.

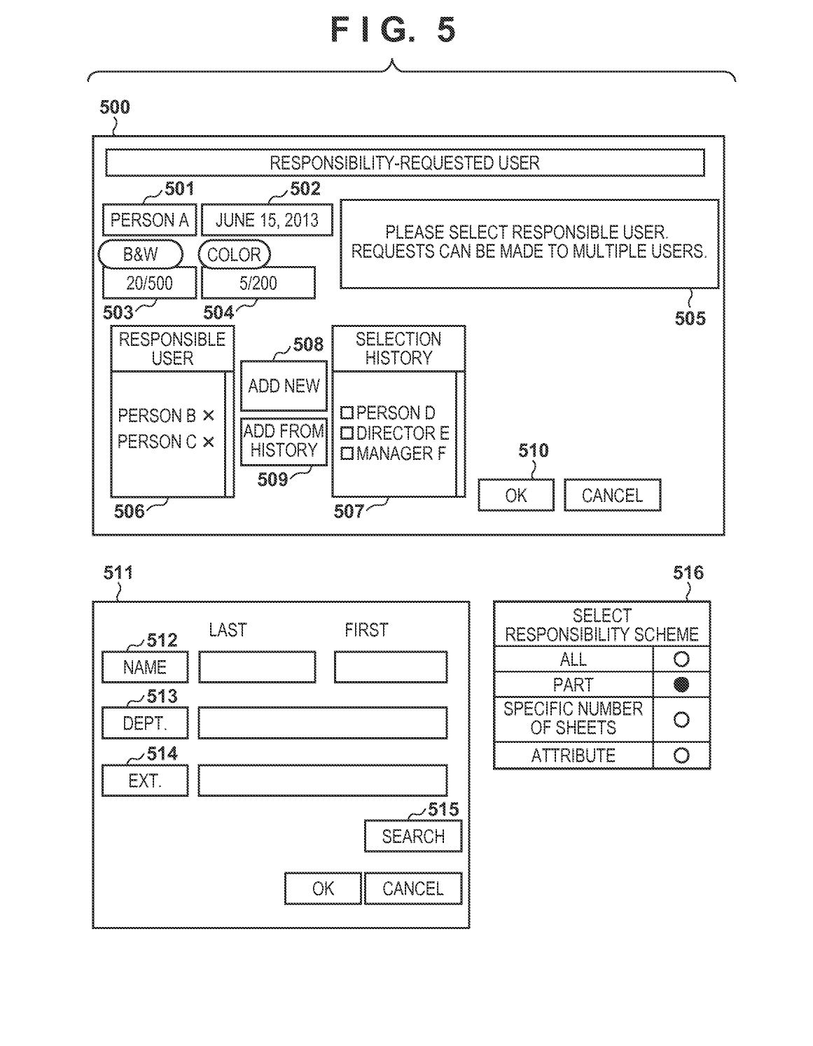

FIG. 5 illustrates an example of a responsibility-requested user selection screen 500 displayed in the display unit 203 by the CPU 200. This screen 500 is configured of a user ID 501 of the user authenticated in the authentication step of S302, a date 502, current sheet number information 503 and 504, a message region 505. A responsibility-requested user selection portion 506, a selection history 507 indicating selections made thus far, and so on are also displayed. By pressing an add button 508 as an operation for selecting a responsibility-requested user for a number of sheets, a responsibility requesting user selects the responsibility-requested user from a responsibility-requested user search screen 411, which will be mentioned later, and adds the responsibility-requested user to a list in the responsibility-requested user selection portion 506. Although the configuration may be such that only a single responsibility-requested user can be selected, the configuration may also be such that multiple requested users can be selected, as indicated by the selection portion 506 in FIG. 5. Furthermore, the selection history 507 displays a list of users who have thus far been selected as responsibility-requested users. Selecting a user to be set as the responsibility-requested user from this list and pressing an “add from history” button 509 enables that user to be added to the responsibility-requested user selection portion 506 list. When the desired responsibility-requested user has been selected, that user is set as a responsible user by pressing an OK button 510.

A responsibility-requested party search screen 511 shown in FIG. 5 is a screen displayed when the add button 508 is pressed. An example of a responsibility-requested party search will be described next. In the responsibility-requested party search screen 511, a responsibility-requested user can be searched for based on specific information unique to the responsibility-requested user, such as a name 512, a department 513, a telephone extension 514, and so on. By inputting the desired information and pressing a search button, a responsibility-requested user candidate list (not shown) is displayed, and the responsibility-requested user is then set by selecting a desired user from that list and pressing an OK button.

Although the responsibility-requested party search screen 511 is described here as being a separate screen from the responsibility-requested user selection screen 500, it goes without saying that the configuration may be such that the content of the responsibility-requested party search screen 511 is simply a part of the responsibility-requested user selection screen 500.

In the case where the system is configured so that multiple responsibility-requested users can be selected, the configuration may be such that the responsibility requesting user can select how to allocate the responsibility to each of the responsibility-requested users. FIG. 5 illustrates a responsibility scheme selection portion 516, which serves as an example of a UI screen for the responsibility requesting user to set the responsibility for a number of sheets. In the case where multiple responsibility-requested users have been set, the responsibility scheme selection portion 516 is displayed and the responsibility requesting user is asked to select the responsibility scheme for the number of sheets. The configuration can be set so that the responsibility requesting user is allowed to select the responsibility scheme s/he feels is optimal from among responsibility schemes set in advance through system configurations, an administrator, or the like. One user taking responsibility for all sheets, each responsible user taking responsibility for some sheets, and so on can be given as examples of responsibility schemes. It is also possible to set the scheme so that each user is responsible for a specified number of sheets, the number of sheets the user is responsible for can be changed based on user attributes, such as the user being a general worker or a management worker, and so on. However, the responsibility scheme is not intended to be limited to the schemes described here.

Next, in S309, the CPU 200 reads out the finalized job setting information, the output-enabled party list, and the responsibility-requested user list from the RAM 209, associates these pieces of information with each other, and sends the associated information to the print management server 106 as a job. The job setting information, the output-enabled party list, and the responsibility-requested user list are associated with each other by, for example, being provided with shared ID information. These pieces of information may be sent separately as long as they are associated with each other, or may be sent collectively as job data.

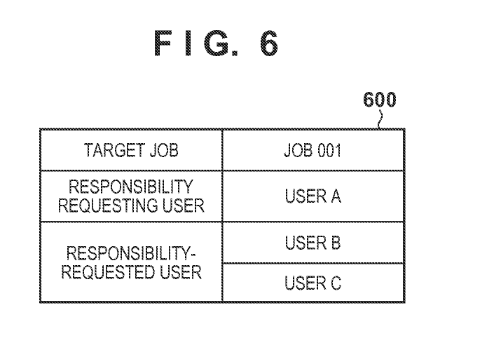

In S310, the print management server 106 receives the job data sent from the user terminal 101. In S311, the CPU 227 registers the job data of the print job received in S310 in an output-standby job queue, and then stores the job setting information, the output-enabled party list, and the responsibility-requested user list in their associated state in the storage 231. The output-standby job queue is managed on a user-by-user basis, and jobs input by the user are managed as a list in the job queue. In S312, under the control of the CPU 227, the count control unit 236 determines the responsibility-requested user from the responsibility-requested user list included in the job data received in S310, creates responsibility request information for the responsibility-requested user, and saves this information in the storage 231. An example of responsibility request information 600 saved at this time is shown in FIG. 6. In this example, the responsibility request information 600 includes a job ID, a responsibility requesting user ID, and a responsibility-requested user ID for the process for assigning responsibility. The responsibility request information can further include a number of sheets the user is responsible for, detailed job setting information, and so on. In the present embodiment, the count control unit 236 is denoted as a single module connected to the system bus 237 of the print management server 106, but the count control unit 236 may be realized as software having the same functionality. In this case, the count control unit 236 is realized as software executed by the CPU 227.

In S313, the CPU 227 sends, to the user terminal 101, a processing complete notification indicating that the registration of the job in the output-standby queue and the creation of the responsibility request information has been completed. In S314, the print management server 106 receives the sent processing complete notification, and finishes setting the print job including the responsibility request information.

Flow from Job Execution to Sheet Number Addition

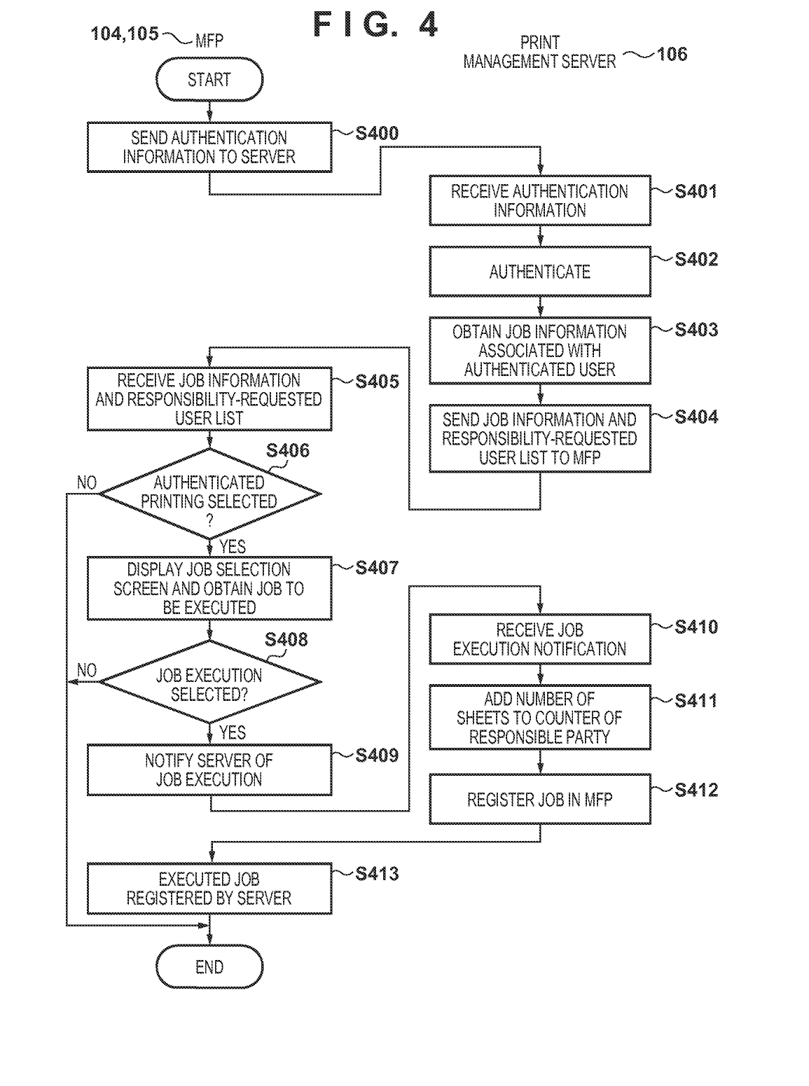

FIG. 4 illustrates an example of a flow from when a job is executed to when a number of printed sheets is added to an account of the responsibility-requested user, in the case where a job for which responsibility has been requested through the flow shown in FIG. 3 is printed by the MFP 104. S400 is a step in which the CPU 211 sends, to a print server, authentication information of a user who can output a job, which has been registered in the MFP 104 using a user ID and a password, a non-contact smartcard, or the like. Here, the user who actually operates the MFP and executes the job will be referred to as a “job executor”.

S401 is a step in which the print management server 106 receives the authentication information sent from the MFP 104 and stores that information in the RAM 234. In S402, the authentication unit 235 verifies the user authentication information received in S401 and identifies the job executor who is using the MFP 104. In S403, the CPU 211 obtains, from the output-standby queue held in advance, a list of jobs set for a job output-enabled party by the executor identified in S402. Furthermore, the CPU 211 obtains the responsibility-requested user list held in association with the obtained job. In S404, the list of jobs obtained in S403 and the responsibility-requested user list associated with the jobs are sent to the MFP 104.

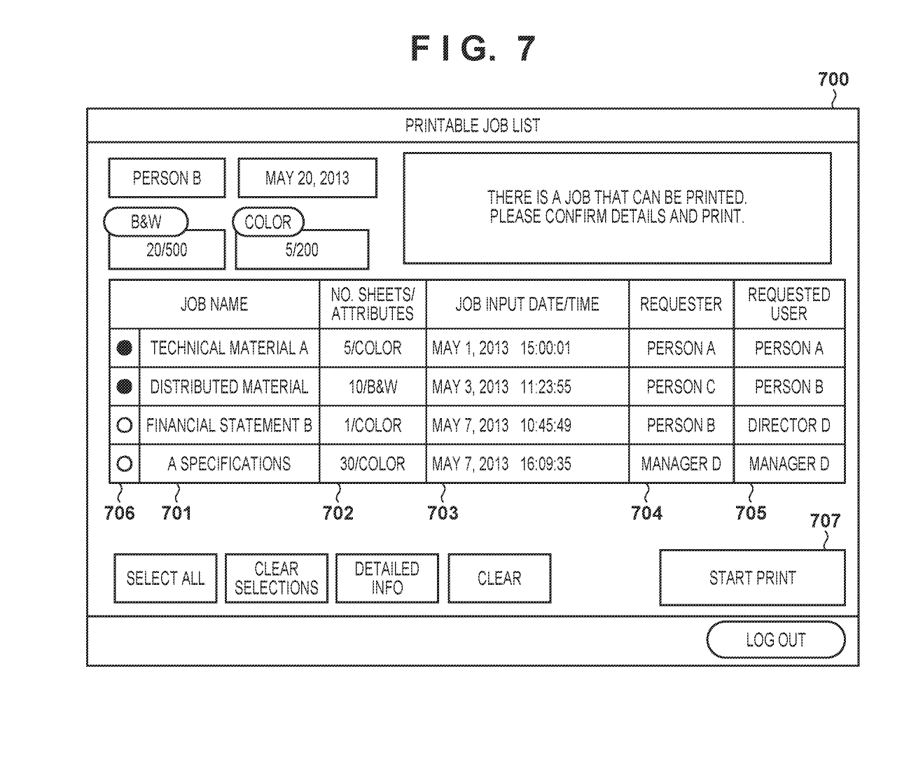

In S405, the MFP 104 receives the job list sent from the print management server 106 and the responsibility-requested user list associated with the jobs. In S406, the CPU 211 determines whether or not the executor has operated the operating unit 212 of the MFP 104 and selected authenticated printing. The present flow ends in the case where authenticated printing has not been selected. However, the process moves to S407 in the case where authenticated printing has been selected. S407 is a step in which the CPU 211 displays the job list received in S403 and the responsibility-requested users associated with the jobs in the operating unit 212, which also functions as a display unit, and allows the executor to select the job to be executed. FIG. 7 is a diagram illustrating an example of a job selection screen 700 displayed in operating unit 212. Job names 701 indicating jobs that can be executed, sheet number and attribute information 702 for each job, a job input date/time 703, and so on are displayed in the job selection screen 700. Usernames (owner names) 704 of the parties who set the jobs and who are requesting responsibility to be taken for the number of printed sheets and usernames 705 indicating the responsibility-requested users are also displayed in the list in association with the respective jobs. The executor can select the job to be executed by viewing the list and tapping the touch panel, for example. Feedback is provided in the screen by, for example, changing a check box 706 for the selected job from a blank box to a checkmark. Meanwhile, the charge for a job may be assigned to the requesting owner of that job in the case where no responsibility-requested user is specified, for example. In this case, the same username is displayed for both the responsibility-requested user 705 and the requestor 704. In S408, the CPU 211 determines whether or not the executor has operated the operating unit 212 of the MFP 104 and selected job execution. Selecting job execution corresponds to pressing a print start button 707 in the job selection screen 700 shown in FIG. 7, which is displayed in the touch panel, for example. In the case where the job is executed, the process moves to S409, whereas in the case where the job is canceled, the flow ends. S409 is a step in which the CPU 211 sends, to the print management server 106, a job execution notification for the finalized job.

In S410, the print management server 106 receives the job execution notification sent from the MFP 104. In S411, the CPU 227 identifies the executed job using the job execution notification received in S410, and reads out the responsibility request information associated with the job from the storage 231. Then, the CPU 227 controls the count control unit 236 to increment the counter of the responsibility-requested user (called simply a “counter”) in accordance with the selected responsibility scheme. In S412, the CPU 227 sends job data requested by the job execution notification received in S410 to the MFP 104, and registers that data. S413 corresponds to a flow through which the CPU 211 executes the job sent from the print management server.

As described thus far, according to the present embodiment, the user to which the number of printed sheets is added is made to be variable, which makes it possible to properly specify the user who is to take responsibility, or in other words, be charged, for part or the entire job, for a variety of specific use cases. Furthermore, employing a configuration in which the user who set the print job can select the user requested to take responsibility for the number of printed sheets makes it possible to assign responsibility for the number of sheets to a user based on the documentary printed, the printing conditions, and so on.

Although the present embodiment has been described assuming a system in which the executor of a job can be specified, the present embodiment can also be carried out in a system in which the executor of a job cannot be specified. In this case, it is preferable for the relationship between the responsibility requesting user and the output-enabled party described above to be fixed to a relationship specified in advance by an administrator.

### Second Embodiment

The first embodiment describes a configuration and a flow in which the user to which the number of printed sheets is added is made variable, and the user that sets the print job can select the user requested to take responsibility for the number of printed sheets. That is, a responsibility request, or in other words, a finalized responsibility assignment, is made. The present embodiment will describe a configuration in which the responsibility-requested user can furthermore select whether or not to take responsibility.

In the second embodiment, the print job setting/processing flow shown in FIG. 3 is not changed, but the flow from executing a job to adding a number of sheets to the responsibility-requested user shown in FIG. 4 is changed. Furthermore, a flow through which the responsibility-requested user selects whether or not to take responsibility has been added. The present embodiment focuses on the points that have been changed.

Flow from Job Execution to Notification of Sheet Number Responsibility Request

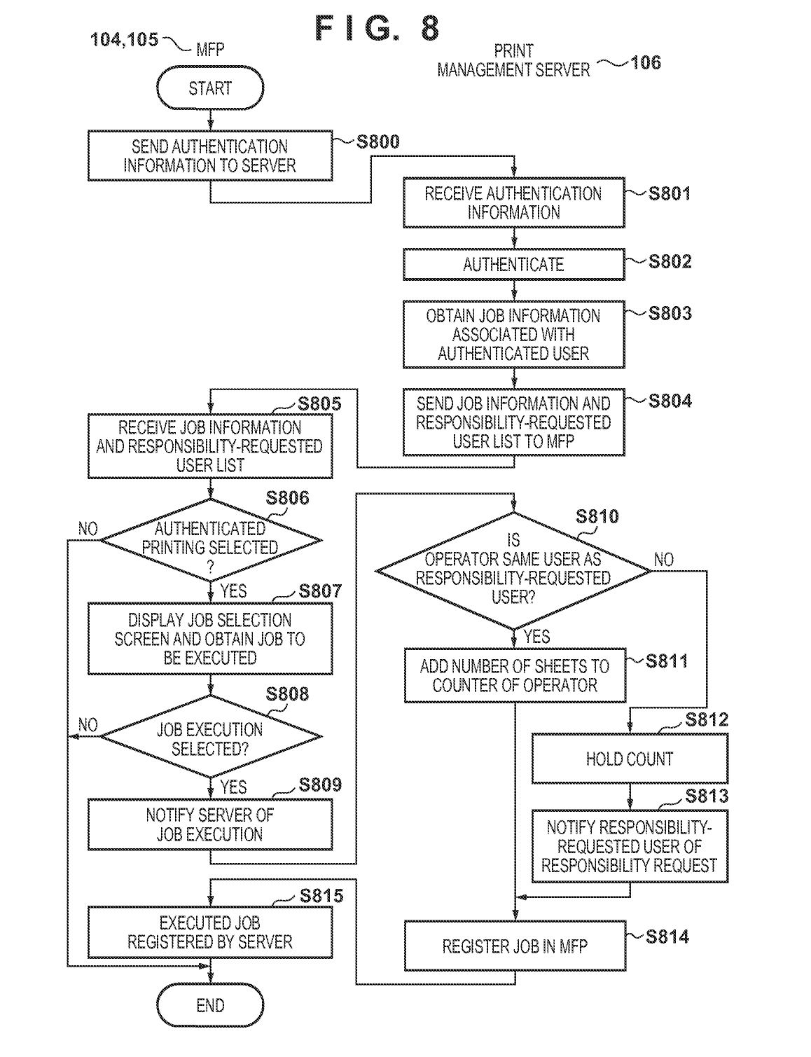

FIG. 8 illustrates a job execution flow in the case where the responsibility-requested user can select whether or not to take responsibility. FIG. 8 serves as a substitute for FIG. 4 in the first embodiment. S800 to S809 are the same as S400 to S409 in the flow shown in FIG. 4, and thus descriptions thereof will be omitted.

In S810, the CPU 227 of the print management server 106 compares the responsibility-requested user of the executed job with the user ID of the executor based on the job execution notification received from the MFP 104 and determines whether the users are the same. The process moves to S811 in the case where the users are the same, and moves to S812 in the case where the users are not the same. S811 is a step in which the CPU 227 adds a number of printed sheets for the print job instructed to be executed to the counter of the executor, who is the responsibility-requested user. As described in the first embodiment, the job and the responsibility-requested user are displayed in association with each other in the job selection screen 700 displayed in the step of determining to execute the job. As such, the executor executes the job having accepted that s/he has been requested to take responsibility; because it is determined that approval has been given, the number of sheets can be added in S811. The responsibility-requested user can still select whether or not to take responsibility for the number of sheets, which is the purpose of the present embodiment, even if S810 and S811 are omitted from the flow shown in FIG. 8. However, providing S810 and S811 makes it possible to create a system that is more usable for the user.

S812 is a step in which the CPU 227 puts the process for adding the number of sheets of the executed job on hold and saves held sheet number information in the storage 231. Here, in addition to the number of printed sheets for which the adding has been placed on hold, the held sheet number information can include the usernames of the parties requesting and requested to take responsibility, a request date/time, the job ID, job details, and the like. The same content can also be stored by associating the held sheet number information with the responsibility request information.

In S813, the CPU 227 notifies the responsibility-requested user that a responsibility request has been made due to the job being executed. The notification method may employ email, a system that displays a pop-up in a resident application, or may provide a notification using a display the next time the responsibility-requested user logs into the MFP. S814 and on are exactly the same as S412 and on in FIG. 4, and thus descriptions thereof will be omitted.

Flow for Selecting Whether or Not to Take Responsibility

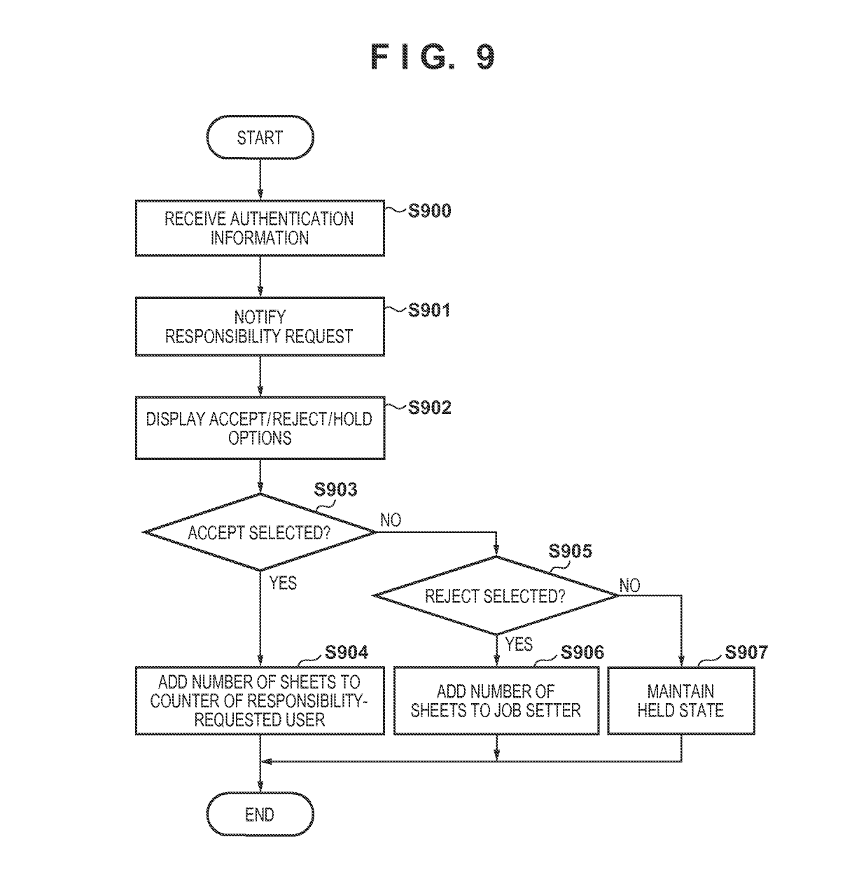

FIG. 9 illustrates a flow carried out in the case where the determination of S810 indicates “no”, and is a flow for communicating that a responsibility request has arrived and allowing the responsibility-requested user to select whether or not to take responsibility for the held number of printed sheets in the case where the responsibility-requested user has logged into the MFP 104.

S900 is a step in which the print management server 106 receives the authentication information entered into the MFP 104 and the authentication unit 235 recognizes that the responsibility-requested user has logged into the MFP 104. S901 is a step in which, in response to the responsibility-requested user logging into the MFP 104 in S900, the print management server 106 notifies the responsibility-requested user who logged into the MFP 104 that a responsibility request has arrived.

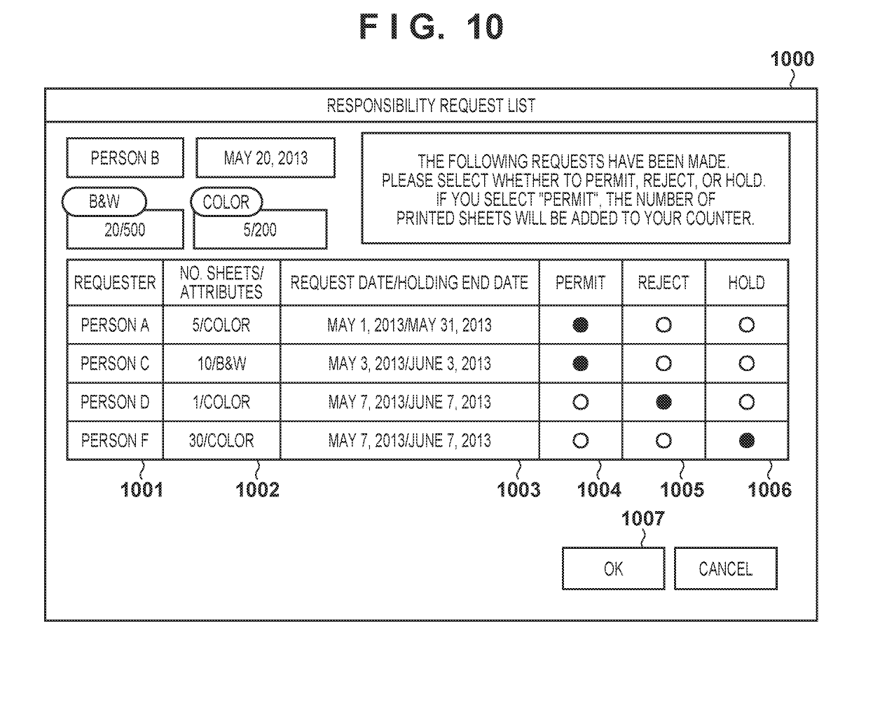

In response to the responsibility request, the MFP 104 notifies the responsibility-requested user of the responsibility request through a display in the UI screen. S902 is a step in which the print management server 106 operates the MFP 104 and allows the responsibility-requested user to select whether or not to take responsibility for the requested number of sheets. An example of the UI screen displayed in the MFP 104 at this time is shown in FIG. 10.

A responsibility permission selection screen 1000 indicates a responsibility requesting user 1001, job information 1002 indicating a number of sheets, job attributes, and so on, and a date/time 1003 when a request was made, in addition to user information of the user who is logged in. In this screen, the responsibility-requested user is a person B, and responsibility requests have come from persons A, C, D, and F, who are responsibility requesting users. A permit check box 1004, a reject check box 1005, and a hold check box 1006 are furthermore provided on a job-by-job basis. The responsibility-requested user can select whether to accept responsibility, reject responsibility, or temporarily place the decision on hold based on this displayed information. For example, the responsibility request from person A is originally a print request from person B, and thus a determination can be made to permit the responsibility, whereas the reason for the request from person F is unclear and thus the request can be temporarily held and confirmed. The owner of each job may be displayed in order to carry out such determinations. In S903, the CPU 227 determines whether “permit” has been selected in S902. The process moves to S904 in the case where “permit” has been selected, and moves to S905 in the case where “permit” has not been selected. Note that when a radio button for permit 1004 or reject 1005 is selected and an OK button 1007 is pressed, it is determined that “permit” (in other words, acceptance) or “reject” has been selected.

S904 is a step in which, in response to the responsible user selecting to permit responsibility being taken in S902, the CPU 227 operates the count control unit 236 so as to add the number of printed sheets to the counter of the responsibility-requested user in accordance with the selected responsibility scheme. In S905, the CPU 227 determines whether the responsibility-requested user has selected “reject” in S902. The process moves to S906 in the case where “reject” has been selected, and moves to S907 in the case where “reject” has not been selected.

S906 is a step in which, in the case where the responsibility-requested user has selected “reject” in S902, the CPU 227 operates the count control unit 236 so as to add the number of printed sheets that was expected to be added to the responsibility-requested user who rejected the responsibility to the counter of the responsibility requesting user.

S907 is a step in which, in response to the responsibility-requested user selecting “hold” in S902, the CPU 227 maintains a held state without performing the process for adding the number of sheets.

As described thus far, according to the present embodiment, enabling the responsibility-requested user to select whether or not to take responsibility for the number of printed sheets makes it possible to allow for the requested party to consider cases in which s/he should take responsibility and assign responsibility for some or all of the number of printed sheets to a user that has accepted the responsibility.

Although the present embodiment describes a case in which the responsibility request is made through the MFP 104, the embodiment can also be applied in the case where the notification destination is the user terminal 101, 102, or 103. It is furthermore possible to simplify the flow. For example, the flow carried out in the case where a rejection is made may be eliminated, and the held state can be continued in the case where the user has not accepted responsibility. This can be realized by carrying out a selection of accepting or holding in S902 and eliminating S905 and S906 from the flow.

### Third Embodiment

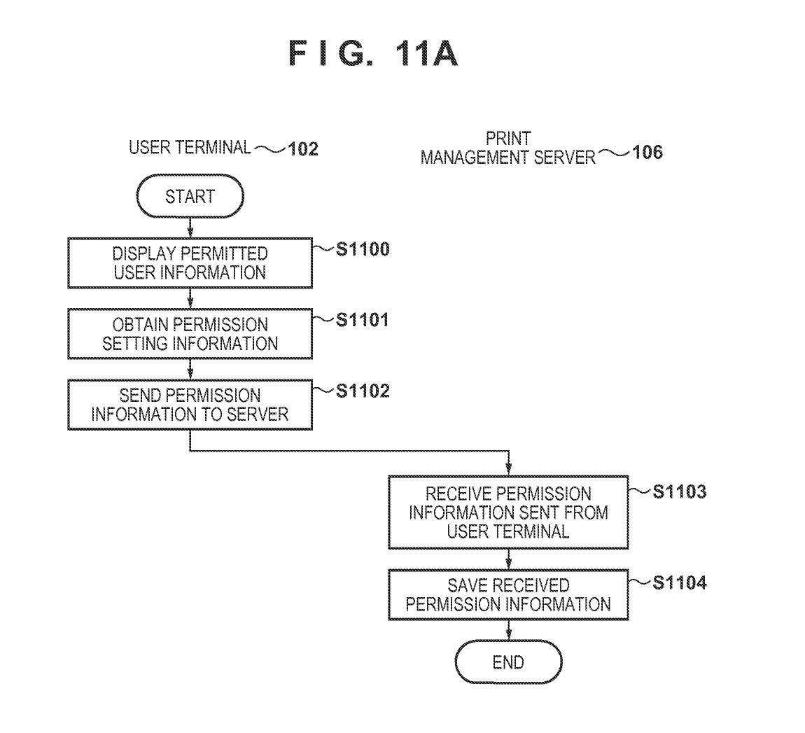

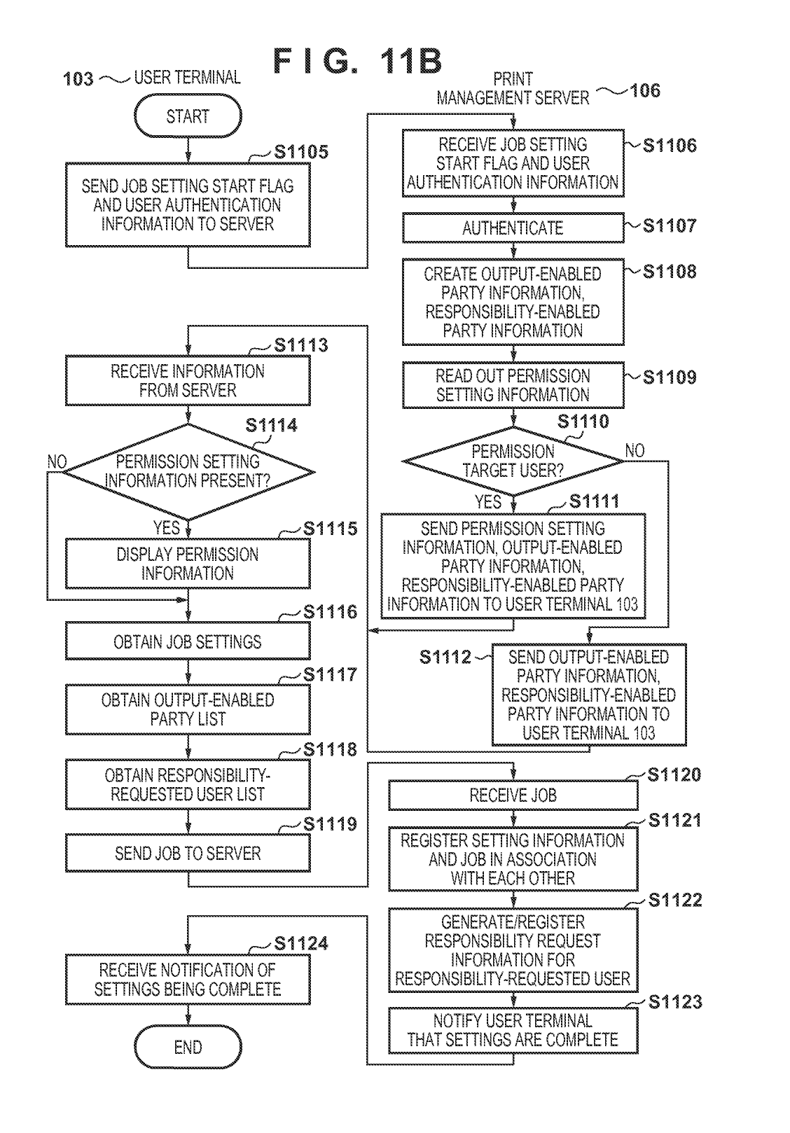

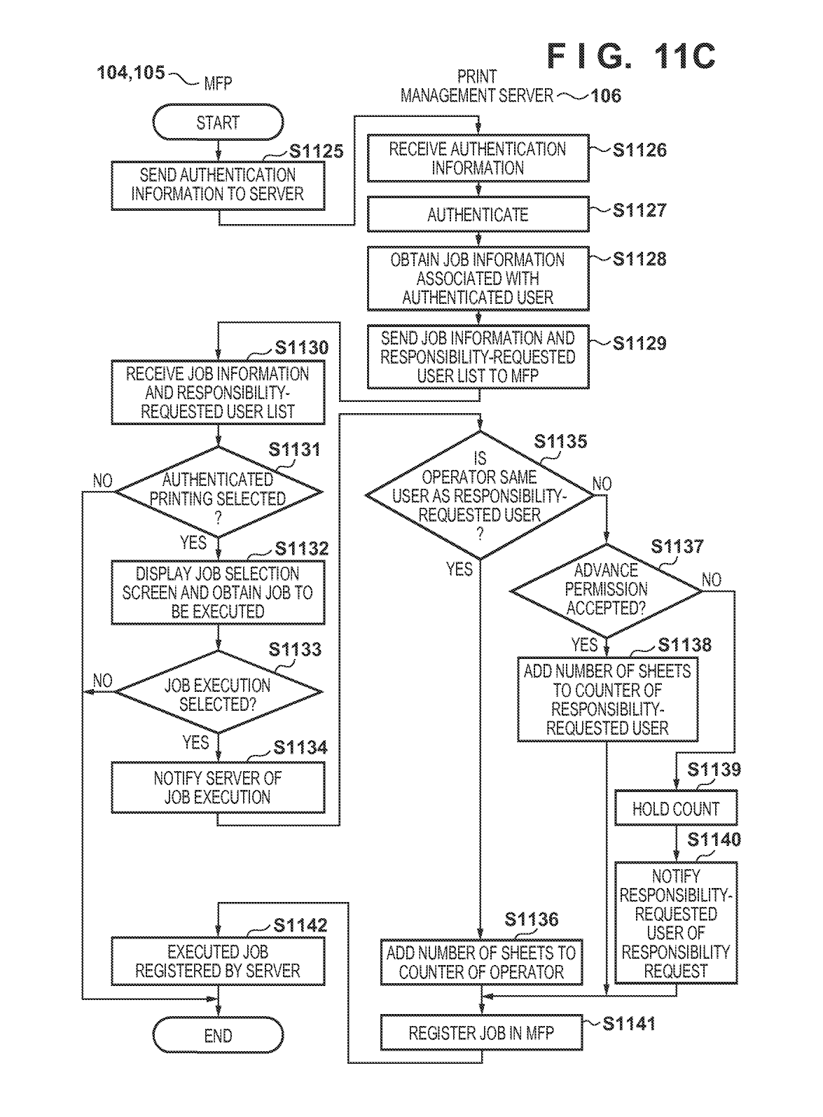

The embodiments described thus far have discussed systems based on requesting responsibility to be taken after a job has been started, or in other words, an ex post facto acceptance of responsibility. The third embodiment describes a configuration in which, in the case where users have agreed on the assignment of responsibility for a number of printed sheets, a process for issuing responsibility permission before the job is set and assigning responsibility without an ex post facto flow that follows the start of the job is carried out, using the flows illustrated in FIG. 11A, 11B, and 11C. The following assumes that the terminal of the user issuing the responsibility permission is the terminal 102, and the terminal of the user that receives the responsibility permission and sets the job is the terminal 103.

Flow When Registering Permission Information

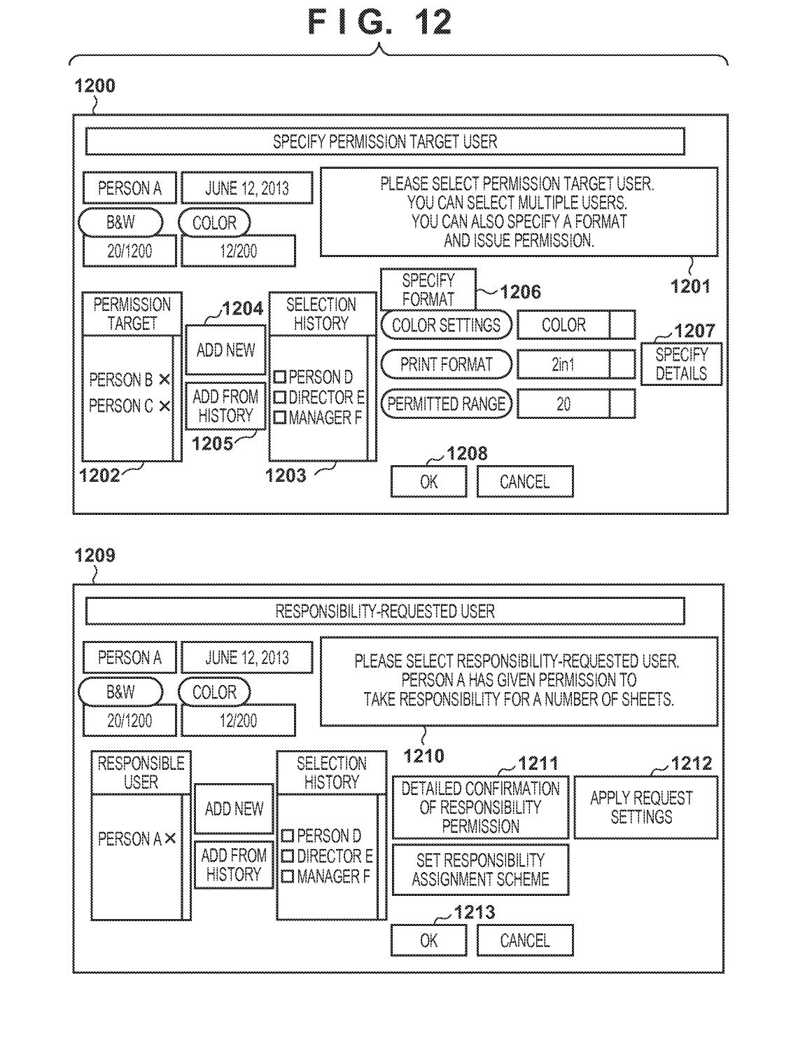

FIG. 11A illustrates a flow carried out when the user who issues the responsibility permission registers permission information in the print management server 106. In S1100, the user terminal 102 obtains, from the print management server 106, a user list indicating users to which the responsibility permission is issued, or in other words, users that can be set as users to be permitted (called “permission target users”), and displays this list in a setting screen. If the requesting user that makes a responsibility request to the user to which the responsibility permission is issued is a permission target user set in advance, the user that issues the responsibility permission (called a “permission-issuing user”) accepts that responsibility request. FIG. 12 illustrates an example of a permission target user specifying screen 1200. The permission target user specifying screen 1200 is configured of a message box 1201, permission target user selection boxes 1202 and 1203, a permission format setting region 1206, a permission format detail setting button 1207, and so on. The message box 1201 indicates simple instructions used when determining the permission target user. The permission target user selection box 1202 displays a list of selected permission target users. Users can be added to this box by pressing an add new button 1204 and searching for user, selecting a user from a selection history 1203 and pressing an add from history button 1205, and so on. Conditions such as an output format used when taking responsibility for a number of printed sheets can be restricted using the permission format setting region 1206. In other words, using the settings makes it possible to avoid taking responsibility in the case where a printed material does not meet the specified conditions. Although the items that can be set here include color settings, a printing format, a number of sheets, and so on, the items are not limited thereto, and the configuration may be such that any item provided in the MFP can be registered. For example, in FIG. 12, the assignment of a number of printed sheets can be accepted as long as the format settings 1206 specify that the print job is color or black and white, the layout is 2-in-1, and the number of sheets is no greater than 20. Note that the specified number of sheets may refer to a number of sheets when printing onto one side only, and half that number, namely 10, may be set in the case of double-sided printing, for example. In the case where the settings screen cannot be displayed in single screen due to UI-based restrictions or the like, the configuration may be such that simplified general settings items can be set in the permission target user specifying screen 1200 and detailed settings can be made by pressing the detail setting button 1207. When all of the settings are finished, the user finalizes the settings by pressing an OK button 1208.

In S1101, the CPU 200 of the user terminal 102 obtains the permission setting information set in S1100. The permission setting information includes the information set through the user interface shown in FIG. 12. This includes at least the user information of the permission-issuing user and the user information of the permission target user, for example. Furthermore, in the case where the output format is restricted when taking responsibility, the permission setting information may include various types of setting information such as conditions that have been set, including color settings, print settings, and so on. In S1102, the CPU 200 sends the permission setting information to the print management server 106.

In S1103, the CPU 227 of the print management server 106 receives the permission setting information sent from the user terminal 102 and temporarily holds that information in the RAM 234. In S1104, the CPU 227 saves the permission setting information received in S1103 into the storage 231.

Flow When Permitted User Registers Job

FIG. 11B illustrates a job registration flow in a system configured so that responsibility permission can be issued in advance. The flow for inputting a job has already been described, and thus only the differences will be discussed here. S1105 to S1108 and S1112 are the same as S300 to S304 in FIG. 3.

S1109 is a step in which the CPU 227 of the print management server 106 reads out the permission setting information saved in the storage 231. In S1110, the CPU 227 compares the authentication information obtained in S1107 with the permission target user from which the permission setting information read out in S1109 can be obtained, and the process moves to S1111 in the case where the user is the permission target user. The process moves to S1112 in the case where the user is not the permission target user. In S1111, the CPU 227 sends the permission setting information, the output-enabled party information, and the responsibility-enabled party information to the user terminal 103.

In S1113, the user terminal 103 receives the information sent by the print management server 106 in S1111 or S1112. In S1114, the CPU 200 of the user terminal 103 determines whether the information received from the print management server 106 includes the permission setting information. The process moves to S1115 in the case where the permission setting information is included and to S1116 in the case where the information is not included. S1115 is a step in which the CPU 200 displays the permission information in the screen for setting the job. FIG. 12 illustrates an example of a responsibility-requested party screen 1209 in which the permission information is displayed. A message indicating that the responsibility permission has been issued is displayed in a message box 1210. When a detail confirmation button 1211 for the responsibility permission is pressed, a separate screen (not shown) that allows the details of the permission to be confirmed is displayed, and the responsibility requesting user can confirm the details of the responsibility permission. An apply request settings button 1212 is a button for automatically applying the user that issued the responsibility permission and the permission setting information set by that user to the job settings. All of the settings can be completed with a single touch by pressing this button. The flow then proceeds from S1116 to S1120, which correspond to S306 to S310 described earlier with reference to FIG. 3, and proceeds to a process for registering the job.

In S1121, the CPU 227 of the print management server 106 registers the job data in the output-standby queue, and saves the job setting information, the responsibility permission information, the output-enabled party list, and the responsibility-requested user list in the storage 231 while maintaining the association between those pieces of information. If there is responsibility permission information, the responsibility permission information is associated with the print job. The flow then proceeds from S1122 to S1124, which correspond to S312 to S314 described earlier with reference to FIG. 3, and the job registration ends.

Flow for Printing Job for Which Responsibility Permission Has Been Received

FIG. 11C illustrates a job printing flow in a system configured so that responsibility permission can be issued in advance. The flow for printing a job has already been described with reference to FIGS. 4 and 8, and thus only the differences will be described here. S1125 to S1136 and S1139 to S1142 correspond to S800 to S815 in FIG. 8, whereas S1137 and S1138 are new steps according to the present embodiment.

In S1137, the CPU 227 of the print management server 106 determines whether responsibility permission has been issued by the responsibility-requested user for the job included in the received job execution notification, by reading out the responsibility-requested user list and the permission setting information saved in association with the job. In the case where the responsibility permission information is saved in association with the job and the responsibility-requested user is the user that issued the permission, it is determined that there is advance permission (or advance acceptance) for the responsibility-requested user, and the process moves to S1138; in the case where the information is not saved, however, the process moves to S1139. Note that in the case where conditions for accepting a printing format and the like are specified, it is determined that there is advance permission in the case where those conditions are met. In S1138, the CPU 227 determines that the responsibility-requested user has granted responsibility permission for the job to be executed, and adds the number of printed sheets the user is to be responsible for to the counter of that responsibility-requested user (that is, the permission-issuing user). In the case where there are multiple responsibility-requested users that have accepted responsibility in advance, the number of sheets those users are responsible for are added to the counters of those users in the same manner. The flow then proceeds from S1141 to S1142 in the same manner as described earlier, and the job execution ends.

As described thus far, according to the present embodiment, the responsibility-requested user can issue permission to take responsibility in advance to a specific user. By employing such configuration, in the case where users are in agreement regarding a number of sheets to be handled, a process for taking responsibility for a number of sheets can be carried out without a flow for accepting the responsibility after the job is started, which makes it possible to improve the usability for the users. Furthermore, combining this embodiment with the second embodiment makes it possible to realize a configuration in which the number of sheets the user is responsible for can be communicated at any desired timing.

### Fourth Embodiment

A fourth embodiment describes a method in which, in the case where a request to take responsibility for a number of printed sheets is made, responsibility permission is issued, and so on, and an attempt is made to set a greater number of sheets than a predetermined limit number set for the responsibility-requested user, the extra amount can be set as a responsibility request for yet another user.

Flow When Requesting Responsibility for Extra Number of Sheets to Yet Another User

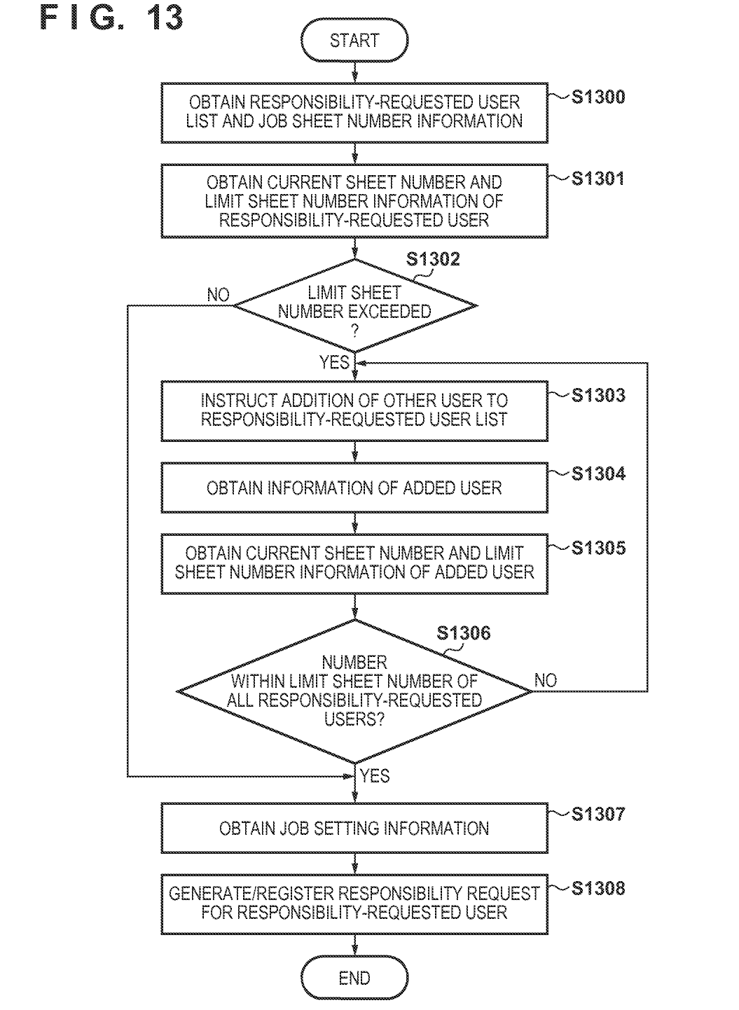

FIG. 13 illustrates a flow carried out in the case where an attempt is made to set a greater number of sheets than a limit number set for the responsibility-requested user and the extra amount is set as a responsibility request for yet another user. In S1300, the CPU 227 of the print management server 106 obtains the responsibility-requested user list and sheet number information for the job. The information may be received as details sent to the print management server 106 after the job is set in the user terminal 101 as described in the first embodiment, or may be obtained sequentially through communication carried out while the job is being set in the user terminal 101, for example. In S1301, the CPU 227 obtains, based on the obtained information of the responsibility-requested user, current sheet number information (a current counter value) and limit sheet number information for that user, from the storage 231. In S1302, the CPU 227 determines whether the limit sheet number has been exceeded by adding the number of sheets obtained in S1300 to the current number of sheets obtained in S1302 and comparing the resulting sum to the limit sheet number. The process moves to S1303 in the case where the limit sheet number has been exceeded and to S1307 in the case where the limit sheet number has not been exceeded. The number of sheets by which the limit sheet number has exceeded is also saved in the storage 231 as extra sheet number information when the comparison is made with the limit sheet number information.

S1303 is a step in which the print management server 106 carries out control for displaying that another responsibility-requested user will be added in the display unit 203 of the user terminal 101 and starting the acceptance of a responsibility-requested user addition operation. Under the control of the print management server 106, the CPU 200 of the user terminal 101 carries out control for displaying, in a message box 505 shown in FIG. 5, a message requesting another responsibility-requested user to be added, for example. The CPU 200 then stands by for a new responsibility-requested user to be added to a responsibility-requested user selection box 506. Note that the print management server 106 may control the MFP 104 to display users whose limit sheet numbers have not yet been reached as candidates. In S1304, the print management server 106 receives and obtains the information of the added responsibility-requested user sent from the user terminal 101. In S1305, the CPU 227 of the print management server 106 obtains, based on the obtained information of the added responsibility-requested user, the current sheet number information and the limit sheet number information of that user from the storage 231. In S1306, the CPU 227 reads out the extra sheet number saved in S1302, adds that number to the current sheet number of the added responsibility-requested user obtained in S1305, compares the resulting sum to the limit sheet number, and determines whether or not the limit sheet number has been exceeded. In the case where the limit sheet number has not been exceeded, or in other words, in the case where the number of sheets is within the limit sheet number for all of the set responsibility-requested users, the number of sheets each user is requested to take responsibility for is associated with each user and saved in the storage 231, after which the process moves to S1308. In the case where the limit sheet number is exceeded, the process returns to S1303, where the addition of another responsibility-requested user is requested.

In S1307, the CPU 227 receives the finalized job setting information and responsibility-requested user list from the MFP 104, registers the received job in the output-standby queue, and associates the received information with the number of sheets each user is responsible for. In S1308, the CPU 227 creates the responsibility request information for each user based on the set number of sheets each user is responsible for saved in S1306, and saves the information in the storage 231.

As described thus far, according to the present embodiment, in the case where a job that exceeds the limit sheet number for the responsibility-requested user has been set, the extra amount can be set as a responsibility request for another user. Employing such a configuration makes it possible to distribute a number of sheets among several users, which makes it possible to improve the usability for the users.

Although the calculation of the extra number of sheets is carried out in S1302 in the present embodiment, the calculation of the extra number of sheets can be carried out at any time after S1302.

### Other Embodiments

Embodiments of the present invention can also be realized by a computer of a system or apparatus that reads out and executes computer executable instructions (e. g., one or more programs) recorded on a storage medium (which may also be referred to more fully as a ‘non-transitory computer-readable storage medium’) to perform the functions of one or more of the above-described embodiments and/or that includes one or more circuits (e. g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e. g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-270125, filed Dec. 26, 2013, which is hereby incorporated by reference herein in its entirety.

What is claimed is:

1. An information processing apparatus comprising:
a specifying unit that specifies a requested user who is a user requested to take responsibility for some or all of a print amount for printing executed based on print data; and
a generating unit that, based on details of the specifying performed by the specifying unit, generates print data including a requested user list specifying the requested user.

2. The information processing apparatus according to claim 1,
wherein the specifying unit furthermore specifies a method for assigning responsibility for the print amount using the requested user list, and includes the method of assigning responsibility in the print data.

3. The information processing apparatus according to claim 1,
wherein the method for assigning responsibility includes specifying how to distribute the print amount.

4. The information processing apparatus according to claim 1,
wherein the specifying unit furthermore specifies a condition for assigning responsibility for the print amount using the requested user list, and includes the condition in the print data.

5. The information processing apparatus according to claim 4,
wherein the condition includes specifying at least one of color or monochrome, a layout, and a print amount range.

6. The information processing apparatus according to claim 1,
wherein the specifying unit displays a user interface including a list of users who can be selected as the requested user and allows the requested user to be specified from the list.

7. The information processing apparatus according to claim 6,
wherein the list of users who can be selected further includes a list of users who have been selected as the requested user in the past.

8. The information processing apparatus according to claim 1,
wherein the print data further includes a list of users who can instruct the print data to be printed.

9. A non-transitory computer-readable medium on which is recorded a program for causing a computer to function as the information processing apparatus according to claim 1.

10. A print management method comprising:
specifying a requested user who is a user requested to take responsibility for some or all of a print amount for printing executed based on print data; and
based on details of the specifying performed in the specifying, generating print data including a requested user list specifying the requested user.

11. An information processing apparatus that manages print amounts on a user-by-user basis, the apparatus comprising:
a unit that receives, from a first terminal, print data including a requested user list of users requested to take responsibility for some or all of a print amount for printing executed based on print data;
a unit that generates responsibility request information based on the requested user list and saves the responsibility request information;
a unit that sends and registers the print data in an image forming apparatus; and
a counting unit that, in response to a notification from the image forming apparatus that the print data is to be printed, counts some or all of the print amount based on the print data as a print amount for the requested user in the case where the requested user is specified in the print data.

12. The information processing apparatus according to claim 11,
wherein the responsibility request information includes specifying a method for assigning responsibility in addition to specifying the requested user; and
the counting unit counts some or all of the print amount based on the print data as the print amount for the requested user in accordance with the method for assigning responsibility.

13. The information processing apparatus according to claim 11,
wherein the responsibility request information includes specifying a condition in addition to specifying the requested user; and
the counting unit counts some or all of the print amount based on the print data as the print amount for the requested user in the case where the condition is met.

14. The information processing apparatus according to claim 11,
wherein in the case where the print data is to be printed, and the requested user is the same as the user who instructed the print data to be printed, the some or all of the print amount based on the print data is counted as the print amount of the user, whereas in the case where the requested user is not the same as the user who instructed the print data to be printed, a request to take responsibility is communicated to the requested user.

15. The information processing apparatus according to claim 14,
wherein in the case where the request to take responsibility has been accepted by the requested user, some or all of the print amount based on the print data is counted as the print amount of the user, whereas in the case where the request to take responsibility has been rejected, some or all of the print amount based on the print data is counted as a print amount of the party that configured the print data.

16. The information processing apparatus according to claim 14, further comprising:
a saving unit that saves permission information, issued by a permission-issuing user, indicating advance acceptance of the request to take responsibility for the print amount based on the print data set by a permission target user,
wherein in the case where the request to take responsibility has been accepted in advance based on the permission information, some or all of the print amount based on the print data is counted as a print amount for the permission-issuing user without notifying the requested user of the request to take responsibility.

17. The information processing apparatus according to claim 14,
wherein in the case where a value counted as the print amount for the requested user has exceeded a predetermined limit, another requested user requested to take responsibility for the extra amount is furthermore specified and that requested user is notified of the request to take responsibility.

18. The information processing apparatus according to claim 11,
wherein the specifying unit can specify one or more requested users.

19. A non-transitory computer-readable medium on which is recorded a program for causing a computer to function as the information processing apparatus according to claim 11.

20. A print management method that manages print amounts on a user-by-user basis, the method comprising:
receiving, from a first terminal, print data including a requested user list of users requested to take responsibility for some or all of a print amount for printing executed based on print data;
generating responsibility request information based on the requested user list and saving the responsibility request information;
sending and registering the print data in an image forming apparatus; and
in response to a notification from the image forming apparatus that the print data is to be printed, counting some or all of the print amount based on the print data as a print amount for the requested user in the case where the requested user is specified in the print data.

21. A print management system comprising a first terminal, a print management terminal that manages print amounts on a user-by-user basis, and an image forming apparatus,
wherein the first terminal comprises:
a specifying unit that specifies a requested user who is a user requested to take responsibility for some or all of a print amount for printing executed based on print data; and
a generating unit that, based on details of the specifying performed by the specifying unit, generates print data including a requested user list specifying the requested user, and
wherein the print management apparatus comprises:
a unit that receives, from a first terminal, print data including a requested user list of users requested to take responsibility for some or all of a print amount for printing executed based on print data;
a unit that generates responsibility request information based on the requested user list and saves the responsibility request information;
a unit that sends and registers the print data in an image forming apparatus; and
a counting unit that, in response to a notification from the image forming apparatus that the print data is to be printed, counts some or all of the print amount based on the print data as a print amount for the requested user in the case where the requested user is specified in the print data.

22. The print management system according to claim 21, further comprising:
a second terminal;
wherein the permission information is received from the second terminal.
